(19) United States
(12) Patent Application Publication
(10) Pub. No.: US 2022/0051200 A1
(43) Pub. Date: Feb. 17, 2022

(54) TICKET VENDING MACHINE PAYMENTS SYSTEMS AND METHODS

(71) Applicant: Bytemark, Inc., New York, NY (US)

(72) Inventors: Stephanie Schrauth, Brooklyn, NY (US); Nicholas Ihm, Newtown, CT (US); Vishal Arora, Little Neck, NY (US); Shashidhar Yaranal, Bangalore (IN)

(73) Assignee: Bytemark, Inc., New York, NY (US)

(21) Appl. No.: 17/003,217

(22) Filed: Aug. 26, 2020

Related U.S. Application Data
(60) Provisional application No. 63/064,667, filed on Aug. 12, 2020.

(51) Int. Cl. G06Q 20/04; G06Q 50/30; G06Q 20/38; G06Q 20/40; G06Q 20/32; G06Q 20/12; G06Q 20/18; G06Q 30/00; G07B 15/02; G06K 7/14; H04L 29/06

(52) U.S. Cl. CPC G06Q 20/0457; G06Q 50/30; G06Q 20/385; G06Q 20/401; G06Q 20/3226; G06Q 2230/00; G06Q 20/18; G06Q 30/0185; G07B 15/02; G06K 7/1417; H04L 63/08; G06Q 20/127

(57) ABSTRACT

An electronic-ticketing approach in which a user of a mobile device receives a voucher code at a Ticket Vending Machine (TVM) in a transit station, enters the voucher code into the user's mobile device, and sends it to a control unit to receive an electronic ticket from the control unit delivered to the user's mobile device. The voucher code is a randomly-generated, alpha-numeric code that can be displayed on TVM displays and also can be easily be printed on TVM receipts. When the control unit receives the voucher code, it links the electronic ticket to the user before delivering the ticket to the user's mobile device so as to keep a track of the user's usage of the ticket. A software module provides a user app portion for the user's mobile device and a server app portion for the control unit, both of which operate in conjunction with each other.

### TECHNICAL FIELD

The present disclosure generally relates to electronic ticketing for a transit service. More particularly, and not by way of limitation, particular embodiments of the present disclosure are directed to a system and method in which a user obtains an alpha-numeric voucher code from a Ticket Vending Machine (TVM) and sends the code to a controller system using a mobile device to receive an electronic ticket on the mobile device.

### BACKGROUND

Many transit stations, such as train platforms or bus terminals, have electronic ticketing systems, such as TVMs, to improve user experience and efficiently handle passenger traffic. During rush hours, such ticketing systems reduce the load on human operator-based ticketing windows. Because these systems can operate 24 hours a day, they provide an efficient and cost-effective option for round-the-clock ticketing, thereby obviating the need to hire human staff for long hours or during the time when passenger traffic is routinely slow. At a TVM, a passenger may pay for the ticket in cash or with a credit/debit card and the electronic ticket may be displayed on a screen of the TVM as a Quick Response (QR) code, which is a matrix or two-dimensional (2D) barcode. The passenger may then use his/her smartphone or other suitable mobile device to scan the barcode to store the corresponding electronic ticket from the TVM into the memory of the device for later use.

### SUMMARY

Although the above-mentioned option for electronic ticketing is available through a TVM, it has certain limitations. For example, the production and scanning of a QR code (or other symbol of similar nature) from a TVM screen have certain risks including, for example, the risk of possible misuse or unauthorized scanning by another user in the vicinity of the TVM. Furthermore, the QR code scanning can be harder depending on the ambient lighting conditions, TVM screen brightness, screen pixel density, screen contrast, QR code payload/content density, and the like. The reliability of the content extracted from a QR code may depend on the scanning software used in the mobile application processing the QR code. Additionally, the condition and/or resolution of the camera of a user's smartphone also can affect the software's barcode scanning capability.

It is therefore desirable to offer a more robust, TVM-based electronic ticketing option to passengers in a transit system. It is also desirable to offer a simple, yet more secure approach to TVM-based electronic ticketing using a passenger's mobile device.

As a solution, particular embodiments of the present disclosure provide for an electronic-ticketing approach in which a user of a mobile device receives an alpha-numeric voucher code at the TVM. The user may then enter this voucher code into the user's mobile device and wirelessly send it to a control unit, which may then deliver the appropriate electronic ticket to the user's mobile device. The voucher code is non-pictorial in the sense that it is neither a 2D barcode (like the earlier-mentioned QR code) nor a one-dimensional (1D) barcode (such as a Universal Product Code (UPC) on a product package). In particular embodiments, the voucher code is merely a randomly-generated set of alpha-numeric characters. As a result, it can work on almost all kinds of TVM displays and also can be easily be printed on TVM receipts. Furthermore, such a voucher code is easy to read and simple to enter on the screen of the user's mobile device, and there is no need for the user to struggle with the earlier-discussed scanning-related issues plaguing the QR codes. Because the voucher code is to be manually entered into a specific data entry field on a mobile device, it cannot be used in an unauthorized manner (unlike a QR code) through scanning by a different person. In certain embodiments, when the control unit receives the voucher code from the user's mobile device, the control unit links the electronic ticket to the user before delivering the ticket to the user's mobile device so as to keep a track of the user's usage of the ticket. A Voucher Generation and Redemption (VGR) software module as per teachings of the present disclosure may be configured to provide a user app portion for the user's mobile device and a server app portion for the control unit, both of which may operate in conjunction with each other in a client-server configuration. This hassle-free and secure approach to electronic-ticketing may significantly improve the user experience and efficiently handle the passenger traffic at a transit station.

In one embodiment, the present disclosure is directed to a method in a control unit associated with a transit system. The method comprises: (i) receiving, from a TVM in the transit system, a request for a voucher code to be provided to a user of a mobile device for purchase of an electronic ticket for a transit service; (ii) authenticating the received request; (iii) sending the voucher code to the TVM to be provided to the user; (iv) receiving the voucher code sent by the user from the mobile device; and (iv) delivering the electronic ticket to the mobile device.

In another embodiment, the present disclosure is directed to a method in a mobile device for receiving an electronic ticket on the mobile device for a transit service. The method comprises: (i) receiving a voucher code from a user operating the mobile device, wherein the voucher code is an alpha-numeric code and is obtained by the user from a TVM in a transit system for the transit service; (ii) sending the voucher code to a ticketing server in the transit system as part of a request for the electronic ticket, wherein the voucher code enables the ticketing server to link the electronic ticket to the user; and (iii) receiving the electronic ticket from the ticketing server for storage into the mobile device.

In a further embodiment, the present disclosure is directed to a control unit in a transit system. The control unit comprises an interface unit, a memory, and a processor coupled to the interface unit and to the memory. In the control unit, the interface unit is operable to receive, from a TVM in the transit system, a request for a voucher code to be provided to a user of a mobile device for purchase of an electronic ticket for a transit service. In the control unit, the memory is operable to store program instructions and the request for the voucher code. In the control unit, the processor is operable to execute the program instructions, which, when executed by the processor, cause the control unit to perform the following: (i) authenticate the received request; (ii) generate the voucher code; (iii) send the voucher code, using the interface unit, to the TVM to be provided to the user; (iv) subsequently receive, using the interface unit, the voucher code sent by the user from the mobile device; and (v) deliver the electronic ticket to the mobile device using the interface unit.

In yet another embodiment, the present disclosure is directed to a transit system, which comprises a first server, and a second server communicatively coupled to the first server. In the transit system, the first server is operable to send a request to the second server for a voucher code to be provided to a user of a mobile device for purchase of an electronic ticket for a transit service. In the transit system, the second server is operable to perform the following: (i) authenticate the received request; (ii) send the voucher code to the first server to be provided to the user; (iii) receive the voucher code sent by the user from the mobile device; and (iv) deliver the electronic ticket to the mobile device.

The voucher code-based electronic ticketing methodology as per teachings of the present disclosure may provide a simple, convenient, and secure approach for TVM-based ticketing at transit stations. The disadvantages of receiving electronic tickets through scanning of QR codes or other symbols are eliminated in the two-step ticketing approach involving a user's manual input of the voucher code received from a TVM into the user's mobile device and subsequent receipt of the user-specific electronic ticket on the user's device. The electronic ticketing solution presented herein may provide an improved option for TVM-based ticketing at transit stations.

### BRIEF DESCRIPTION OF THE DRAWINGS

In the following section, the present disclosure will be described with reference to exemplary embodiments illustrated in the accompanying figures. For ease of discussion, the same reference numbers in different figures indicate similar or identical items.

FIG. 1 illustrates constituent components of a Voucher Generation and Redemption (VGR) application according to an exemplary embodiment of the present disclosure.

FIG. 2 depicts an exemplary system for implementing the VGR application according to one embodiment of the present disclosure.

FIG. 3 shows an exemplary flowchart illustrating a control unit-based electronic ticket delivery methodology according to one embodiment of the present disclosure.

FIG. 4 shows an exemplary flowchart illustrating a mobile device-based electronic ticket reception methodology according to one embodiment of the present disclosure.

FIG. 5 shows an exemplary illustration of system components to implement the voucher code-based electronic-ticketing methodology according to one embodiment of the present disclosure.

FIG. 6 depicts an exemplary messaging diagram showing exchange of messages among various system components in FIG. 5 to implement the voucher code-based electronic-ticketing methodology according to one embodiment of the present disclosure.

FIG. 7 shows an exemplary TVM receipt with a voucher code according to one embodiment of the present disclosure.

FIGS. 8A-8D provide an exemplary illustration of sample screenshots of the mobile device of FIG. 2 related to the voucher code entry and electronic ticket receipt and display.

FIG. 9 is a block diagram of an exemplary mobile device according to one embodiment of the present disclosure.

FIG. 10 depicts a block diagram of an exemplary computing unit according to one embodiment of the present disclosure.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) in various places throughout this specification are not necessarily all referring to the same embodiment. Furthermore, the particular features, structures, or characteristics may be combined in any suitable manner in one or more embodiments. Also, depending on the context of discussion herein, a singular term may include its plural forms and a plural term may include its singular form. Similarly, a hyphenated term (e.g., “TVM-based,” “electronic-ticketing”, etc.) may be occasionally interchangeably used with its non-hyphenated version (e.g., “TVM based,” “electronic ticketing”, etc.), and a capitalized entry (e.g., “User Application,” “Operating System,” “Control Unit,” etc.) may be interchangeably used with its non-capitalized version (e.g., “user application,” “operating system,” “control unit,” etc.). Such occasional interchangeable uses shall not be considered inconsistent with each other.

It is noted at the outset that the terms “coupled,” “operatively coupled,” “connected”, “connecting,” “electrically connected,” etc., are used interchangeably herein to generally refer to the condition of being electrically/electronically connected in an operative manner. Similarly, a first entity is considered to be in “communication” with a second entity (or entities) when the first entity electrically sends and/or receives (whether through wireline or wireless means) information signals (whether containing address, data, or control information) to/from the second entity regardless of the type (analog or digital) of those signals. It is further noted that various figures (including component diagrams) shown and discussed herein are for illustrative purpose only, and are not drawn to scale.

The terms “first,” “second,” etc., as used herein, are used as labels for nouns that they precede, and do not imply any type of ordering (e.g., spatial, temporal, logical, etc.) unless explicitly defined as such. Furthermore, items or features appearing in different figures may be identified using the same reference numeral for ease of discussion. However, such identification does not imply that the commonly-referenced items/features are identical across all embodiments.

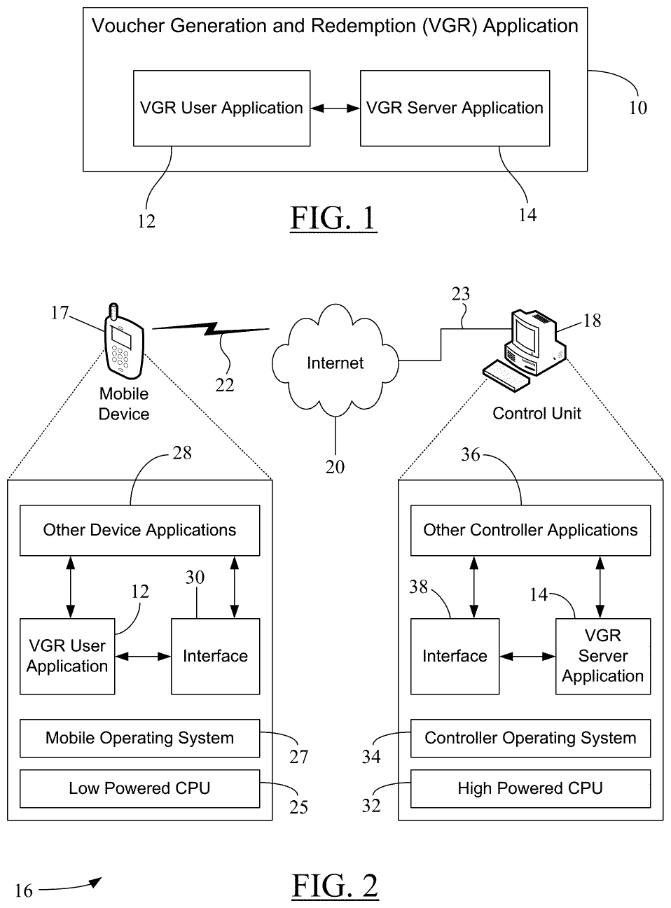

FIG. 1 illustrates constituent components of a Voucher Generation and Redemption (VGR) application 10 according to an exemplary embodiment of the present disclosure. The VGR application 10 may be a software module having various distributed data processing functionalities discussed later below with reference to FIGS. 2-10. Some portion of data processing or computations may be performed locally in a mobile device whereas some other portion of data processing may be performed on a control unit. The VGR application 10 according to one embodiment of the present disclosure may include a VGR User Application (user app) component 12 and a VGR Server Application (server app) component 14. In particular embodiments, the user app 12 and the server app 14 may interact with each other in a client-server configuration. The user app and the server app components may be in bi-directional communication (as discussed below with reference to FIG. 2) with each other, and may together facilitate the voucher code-based electronic ticketing functionality as discussed later. It is noted here that, for ease of discussion, a computer software, program code or module may be referred to as “performing,” “accomplishing,” or “carrying out” a function or process. However, it is evident to one skilled in the art that such performance may be technically accomplished by a processor when the software or program code is executed by the processor. The program execution would cause the processor to perform the tasks or steps instructed by the software to accomplish the desired functionality or result. However, for the sake of convenience, in the discussion below, a processor or software component may be referred to interchangeably as an “actor” performing the task or action described, without technically dissecting the underlying software execution mechanism.

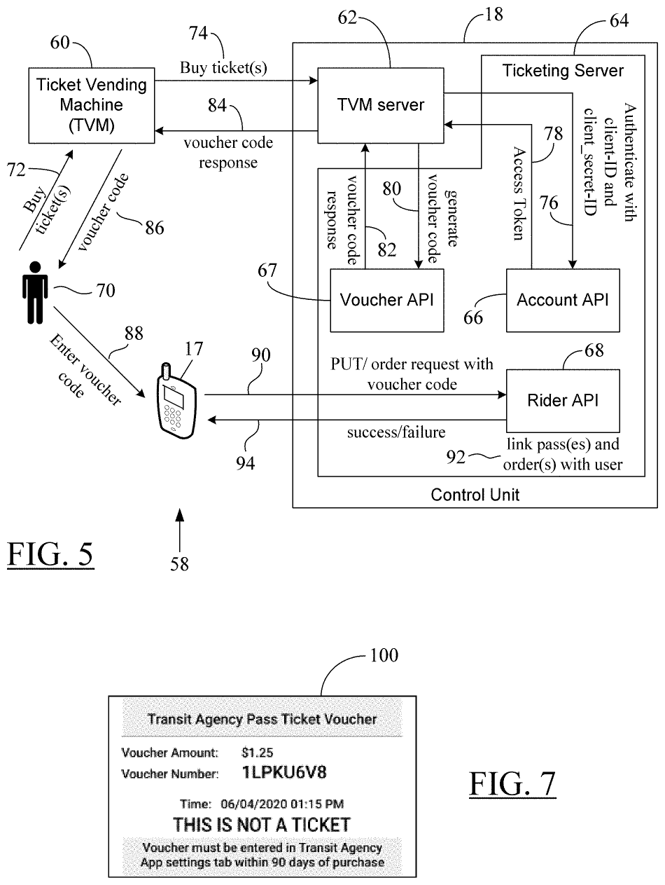

FIG. 2 depicts an exemplary system 16 for implementing the VGR application 10 according to one embodiment of the present disclosure. The system 16 may include a mobile device 17 that is in communication with a control unit 18 via a communication network 20. In one embodiment, the communication network 20 may be a Transmission Control Protocol/Internet Protocol (TCP/IP) based network such as, for example, the Internet. In another embodiment, the communication network 20 may be a different type of packet-switched network. The mobile device 17 may send/receive content from the control unit 18 through its wireless connection—as illustrated by a wireless link 22—with the Internet 20. On the other hand, in some embodiments, the control unit 18 may be connected to the Internet 20 via a wired connection 23, such as an Ethernet connection. In other embodiments, the control unit 18 may communicate with the Internet 20 via a wireless connection (not shown) or a combination of wired and wireless connections. The VGR user app 12 may reside in the mobile device 17, whereas the VGR server app 14 may reside at the control unit 18 as shown in FIG. 2. It is noted here that the terms “mobile device,” “mobile handset,” “wireless handset,” and “User Equipment (UE)” may be used interchangeably hereinbelow to refer to a wireless communication device that is capable of voice and/or data communication. Some examples of such mobile handsets include cellular telephones or data transfer equipments, tablets, and smartphones (e.g., iPhone™, Android™, Blackberry™, etc.). It is observed here that, for ease of discussion, the control unit 18 is shown as a separate device or apparatus. However, the control unit 18 may not have to be a separate computing unit (in hardware or software form) dedicated to carry out the voucher code-based electronic ticketing functionality. In one embodiment, the functionality of the control unit 18 may be implemented in an already-existing physical computing/data processing unit or (non-physical) server software (not shown) at a transit station or elsewhere within a transit system or at a remote location where data related to the transit system (or transit network) may be processed. In another embodiment, the functionality of the control unit 18 may be accomplished using multiple different units in a transit system as discussed later with reference to the embodiment in FIG. 5.

As shown in FIG. 2, the UE 17 may include, inside its housing (not shown), a relatively low-powered Central Processing Unit (CPU) 25 executing a mobile operating system (or mobile OS) 27 (e.g., Symbian™ OS, Palm™ OS, Windows Mobile™, Android™, Apple iOS™, etc.). Because of the battery-powered nature of mobile handsets, the CPU 25 may be designed to conserve battery power and, hence, may not be as powerful as a full-functional computer or server CPU. As further shown in FIG. 2, in addition to the user app 12, the UE 17 may also have one or more mobile applications 28 resident therein. These mobile applications 28 are software modules that may have been pre-packaged with the handset 17 or may have been downloaded by a user into the memory (not shown) of the UE 17. Some mobile applications 28 may be more user-interactive applications (e.g., a mobile game of chess to be played on the UE 17, a face recognition program to be executed by UE 17, etc.), whereas some other mobile applications may be significantly less user-interactive in nature (e.g., UE presence or location tracking applications, a transit pass manager application). The mobile applications 28 as well as the user app 12 may be executed by the processor 25 under the control of the mobile operating system 27. As also shown in FIG. 2, the UE 17 may further include an interface unit 30 to facilitate UE's wireless communication with the control unit 18 via the Internet 20. In particular embodiments, the interface unit 30 may also support other types of wireless connections such as, for example, a cellular network connection, a Wi-Fi connection, and the like. The applications 12, 28 may utilize the wireless interface 30 as needed.

The user app 12 may be configured to run on a variety of mobile devices—Android-based, Apple iOS-based, or any other mobile operating system-based. In particular embodiments, the mobile device 17 may support downloadable applications and may include a User Interface (UI) to facilitate various tasks in support of the voucher code-based electronic ticketing. Such tasks may include, for example, entry of a voucher code by the user, selection of the desired ticket by the user from a group of pre-purchased tickets, intimation of acceptance of the electronic ticket for transit, and the like.

In the embodiment of FIG. 2, the control unit 18 is shown to include a relatively high powered CPU 32 executing an operating system 34 (e.g., Windows™, Mac™ OSX, Linux, etc.). In addition to the server app 14, the control unit 18 also may store in its memory (not shown) other controller-specific applications 36 such as, for example, an application that facilitates Ethernet-based communication with an entry gate system at a transit station, an application that facilitates communication with a “people counting” device or security camera network, an application that interacts with a backend system, and the like. The control unit 18 may be associated with a transit system (such as, for example, a railway system, a bus-based public transport network, and the like) and may communicate with the UE 17 via its own interface unit 38. The interface units 30, 38 may transfer data or information between the mobile device 17 and the control unit 18 via the Internet 20 using appropriate data transfer mechanisms. Thus, in operation, a UE-generated signal may be wirelessly sent (using the interface 30) to the Internet 20 for eventual delivery to the control unit 18 for further processing by its CPU 32. Any response or other signal from the control unit 18 can be provided to the interface unit 38 and eventually delivered to UE's wireless interface 30 (and, hence, to the UE's processor 25 for further processing) via the combination of the Internet 20 and the wireless link 22. In particular embodiments, the interface unit 38 also may support wireless connections such as, for example, a cellular network connection, a Wi-Fi connection, and the like. The applications 14, 36 may utilize the control unit's interface 38 as needed. It is observed here that, in particular embodiments, the mobile device 17 and/or the control unit 18 may be coupled to other networks (not shown) via a wired or wireless connection (whether circuit-switched or packet-switched). Such networks may be voice networks, data networks, or both, and may include, for example, a cellular network, the Internet, a Local Area Network (LAN), a Public Land Mobile Network (PLMN), and the like.

In particular embodiments, the controller unit 18 may be a computer such as, for example, a laptop or a desktop computer, a mobile device, a tablet computer, a single-board computer, or a modular controller such as a Raspberry Pi™ or Arduino™ unit. As discussed in more detail later with reference to FIG. 10, the control unit 18 may support some or all of the following capabilities: wired or wireless connectivity, Universal Serial Bus (USB) connectivity, non-volatile storage such as flash or disk storage, volatile storage using Random Access Memory (RAM) modules, video or Liquid Crystal Display (LCD) display, and a data input device such as a keyboard. It is noted here that, in certain embodiments, there may be more than one control unit 18 installed within a transit system, such as, for example, when multiple TVMs are present and “managed” by different controller units or when different controller units are associated with different transit regions. Generally, the number of controller units may be implementation-specific.

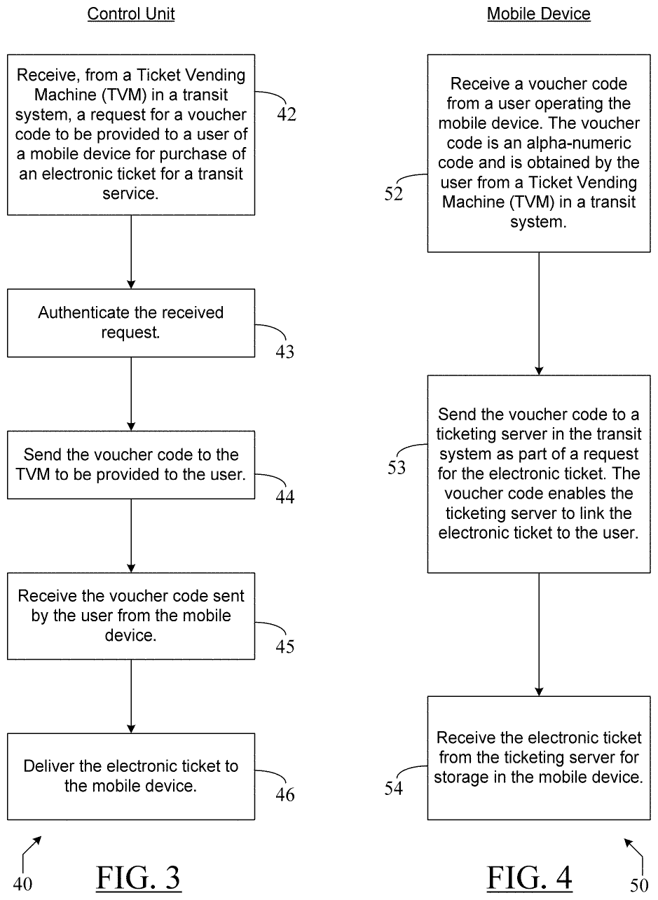

FIG. 3 shows an exemplary flowchart 40 illustrating a control unit-based electronic ticket delivery methodology according to one embodiment of the present disclosure. Various operational tasks shown in FIG. 3 may be performed by the control unit 18 (which is associated with a transit system as noted before) when the server application 14 (and other relevant program code) is executed by the CPU 32. More generally, the control unit 18 performing the steps shown in FIG. 3 may include in hardware and/or software the functionality of the VGR server app 14. It is noted here that in the flowchart 40 in FIG. 3 (and also in the flowchart 50 in FIG. 4), each block represents one or more tasks that can be implemented in hardware, software, or a combination thereof. In the context of software, the blocks represent computer-executable instructions that, when executed by one or more processors, cause the processors to perform the recited tasks. Generally, computer-executable instructions include routines, programs, objects, modules, components, data structures, and the like that perform particular functions or implement particular abstract data types. The order in which the blocks are described is not intended to be construed as a limitation, and any number of the described tasks can be combined in any order and/or in parallel to implement the process shown in the flowchart 40 (as well as in the flowchart 50). For discussion purpose, the tasks in the flowcharts 40, 50 are described with reference to the system configuration of FIG. 2 as described above, although other models, frameworks, systems and environments may be used to implement these tasks.

Initially, at block 42, the control unit 18 may receive, from a TVM in the transit system associated with the control unit 12, a request for a voucher code to be provided to a user of a mobile device (such as the mobile device 17) for purchase of an electronic ticket for a transit service (for example, a bus service, a train service, a ferry service, and the like). The user may be a transit passenger who is availing a transit service in the transit system. A transit vehicle (such as a bus or a train), on the other hand, is a vehicle that is associated with a specific transit service and that makes stops at stations in a transit system. A transit station is a location at which a transit vehicle makes regular stops. It is understood that a transit system may include a number of transit vehicles, transit stations, data sensors, and other system components to successfully operate the transit network for passenger mobility. In some embodiments, the transit system may support mobility or transport of non-passenger items as well, such as specific goods or packages. In the discussion herein, the terms “passenger” and “user”, as well as the terms “control unit” and “controller unit”, may be used interchangeably merely for ease of description.

Referring again to FIG. 3, at block 43, the control unit 18 may authenticate the request received at block 42. Upon ascertaining that the ticket request is from an authorized TVM or other approved ticket-vending system, the control unit 18 may send the voucher code to the TVM to be provided to the user (block 44). As discussed in more detail later, the user may enter the voucher code received from the TVM into a data entry field on the user's mobile device 17 and the VGR user app 12 in the mobile device 17 may send the entered code to the control unit 18. At block 45, the control unit 18 may receive the voucher code sent by the user from the user's mobile device 17. Thereafter, at block 46, the control unit 18 may deliver the corresponding electronic ticket to the user's mobile device 17. The user may thereafter use the electronic ticket for the related transit service. In this manner, a passenger may receive his/her electronic ticket through the combination of TVM and mobile device.

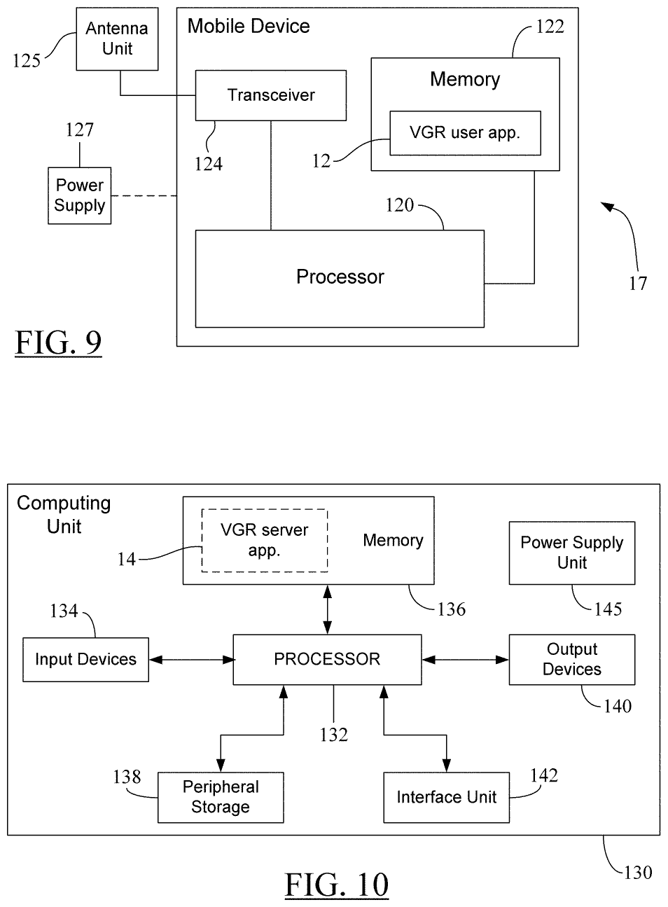

FIG. 4 shows an exemplary flowchart 50 illustrating a mobile device-based electronic ticket reception methodology according to one embodiment of the present disclosure. Various operational tasks shown in FIG. 4 may be performed by the mobile device 17 when the user app 12 (and other relevant program code) is executed by the CPU 25. Initially, the mobile device 17 may receive a voucher code from a user operating the device (block 52). As mentioned earlier, the voucher code may be an alpha-numeric code and may be obtained by the user from a TVM in the transit system. The user may enter the voucher code into a data entry field on the device 17. The user app 12 in the mobile device 17 may trigger the device 17 to send the voucher code (entered by the user) to a ticketing server in the transit system as part of a request for an electronic ticket (block 53). The voucher code may enable the ticketing server to link the electronic ticket (to be delivered to the user's mobile device) to the user. In particular embodiments, the ticketing server may be a part of the control unit 18. Thereafter, at block 54, the mobile device 17 may receive the electronic ticket from the ticketing server for storage in the device 17. Thus, in certain embodiments of the voucher code-based ticketing approach, the mobile device 17 of a passenger may need to submit the voucher code to the control unit 18 before an electronic ticket is delivered to the device for use by the passenger. In one embodiment, the ticket may be stored in a memory of the device 17 (such as the memory 122 in FIG. 9) and is accessible to the user when needed.

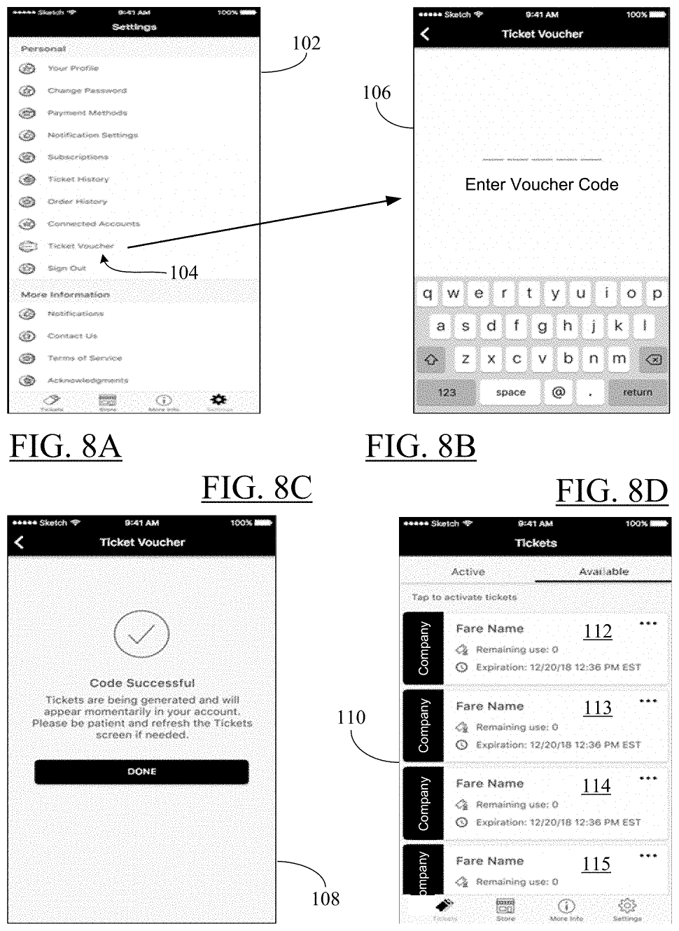

As discussed later with reference to FIG. 8D, in certain embodiments, the electronic ticket may not be a single ticket, but may include a set of digital transit passes that the user may have purchased at the TVM, for example, in a single transaction. Therefore, the term “electronic ticket”, as used herein, may include a single digital ticket/pass or a set of digital tickets/passes depending on the user transaction. It is noted here that the voucher code-based electronic ticket—whether issued as a single digital pass or multiple digital passes—as per teachings of the present disclosure may be used in a transit system that supports hands-free fare validation by allowing a passenger to simply walk through a fare gate at a transit station “hands free” so long as the passenger has a valid, active ticket on his/her mobile device. Such a transit system is discussed in the commonly-owned U.S. Pat. No. 10,375,573.

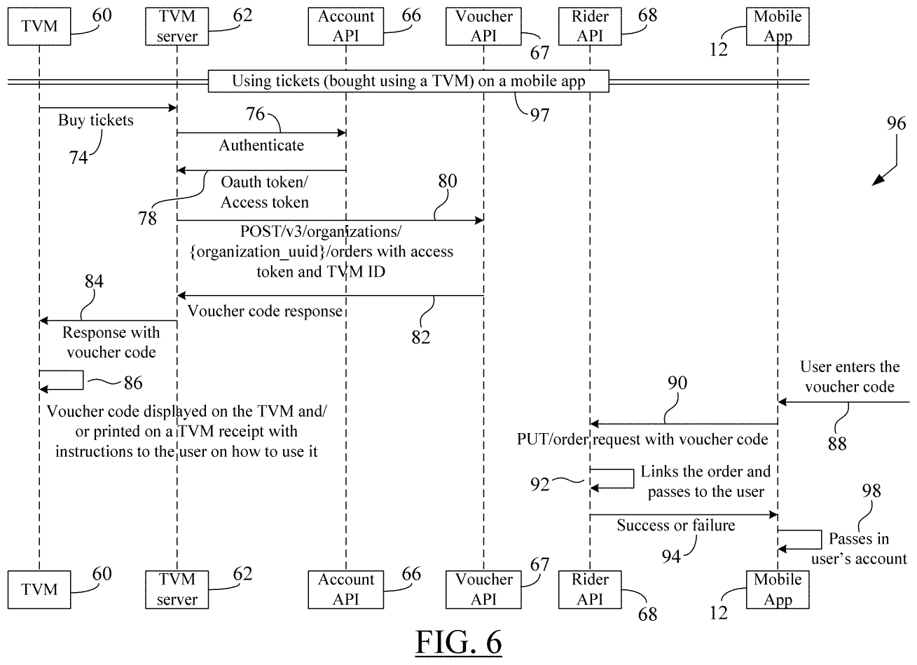

FIG. 5 shows an exemplary illustration 58 of system components to implement the voucher code-based electronic-ticketing methodology according to one embodiment of the present disclosure. For ease of discussion, FIG. 5 will be described along with FIG. 6, which depicts an exemplary messaging diagram 96 showing exchange of messages among various system components in FIG. 5 to implement the voucher code-based electronic-ticketing methodology according to one embodiment of the present disclosure. It is noted that messages common between FIGS. 5 and 6 are identical in functionality, even though some of them may not be identically-worded. Therefore, such common messages are identified using the same reference numerals in both figures. Prior to discussing the operational aspects of the system components in FIG. 5 and related messaging in FIGS. 5-6, a brief overview of the architectural details of these components provided.

As shown in FIG. 5, a TVM 60 may be in communication with the control unit 18, both of which may be a part of a transit system (for example, a railway network, a city-wide passenger bus system, and the like) in certain embodiments. As mentioned before, the TVM 60 may be physically present at a transit station for vending tickets to passengers. On the other hand, some or all hardware/software components of the control unit 18 may be located off the premises of the transit station such as, for example, at a remotely-located central data processing facility or may be implemented in a cloud-computing environment. In the embodiment of FIG. 5, the control unit 18 is shown to comprise a TVM server 62 and a ticketing server 64. As shown, the ticketing server 64 may deploy an account API (Application Programming Interface) 66, a voucher API 67, and a rider API 68. The program code of these APIs may be a part of the VGR server app 14 (FIGS. 1-2). During operation (discussed in more detail later), the account API 66 may provide authentication of a user request for voucher code, the voucher API 67 may generate the requested voucher code, and the rider API 68 may send the appropriate electronic ticket to the user's mobile device 17. In particular embodiments, the functionality of the VGR server app 14 may be implemented through relevant program codes residing in the servers 62, 64. In other embodiments, some portion of the program code of the VGR server app 14 also may reside in the TVM 60 and executed by the TVM 60 to enable the TVM 60 to perform voucher code request-based messaging shown at arrows 74, 84 in FIG. 5 and discussed in more detail later. Alternatively, the firmware or other application in the TVM 60 may be suitably modified to enable the TVM 60 to perform the messaging at arrows 74, 84.

It is noted here that the terms “server” (as in “TVM server” and “ticketing server”) and “client” are used herein for ease of discussion and to more clearly explain the execution of the VGR application 10 (FIG. 1) and its interactions with the mobile device 17 and the control unit 18 (FIG. 2). However, this usage does not necessarily imply that the client-server based model discussed in FIGS. 2 and 5 is the only way to implement the functionality of the VGR app 10 as per teachings of the present disclosure. Furthermore, in certain aspects, the server-based control unit 18 may function as a “server,” whereas in some other respects, it may not function as a server. Similarly, in certain aspects, the TVM 60 or the mobile device 17 may function as “clients” of the server 18, whereas in some other respects, they may not function as client systems.

In the embodiment of FIG. 5, the control unit 18 is shown dotted because the configuration of the control unit 18 of FIG. 2 may not be fixed. Rather, the functionality of the control unit 18 may be flexibly implemented depending on how electronic-ticketing is carried out in a transit system. Thus, for example, in some embodiments, there may be a single entity operating as the control unit 18, as shown in FIG. 2. On the other hand, in particular embodiments, two or more entities—such as, for example, the TVM server 62 and the ticketing server 64 in the embodiment of FIG. 5—may collectively operate as the “control unit” of FIGS. 2-3. In certain embodiments, the TVM 60 may include the functionality of the TVM server 62. In that case, instead of the TVM server 62, the TVM 60 may be a part of the control unit 18 in the embodiment of FIG. 5. In other embodiments, the TVM 60 may include the functionalities of the TVM server 62 as well as the ticketing server 64, resulting in the TVM 60 operating as a TVM as well as the “control unit”. When multiple system components collectively provide the functionality of the control unit 18 of FIGS. 2-3, the VGR server application 14 may be suitably configured to accomplish the relevant functionality in a distributed manner. The foregoing are merely examples of how various units in a transit system may be used—either alone or in combination with other units in the system—to implement the functionality of the “control unit” in FIGS. 2-3 as per teachings of the present disclosure. Additional operational configurations may be devised to implement the functionality of the control unit discussed with reference to FIGS. 2-3. Thus, in some embodiments, the functionality of a “control unit” may be implemented in a manner different from the examples mentioned above. FIG. 10 (discussed later) illustrates architectural details of an exemplary control unit as per teachings of the present disclosure.

In the embodiment of FIG. 5, the TVM 60 may be connected to the TVM server 62 through an Ethernet connection (not shown). In other embodiments, the TVM 60 and the TVM server 62 may be connected to each other via an IP network, such as the Internet 20 shown in FIG. 2. Similarly, the TVM server 62 and the ticketing server 64 may communicate with each other via an Ethernet connection (not shown) or an IP network connection (such as the Internet 20). The communication between the mobile device 17 and the ticketing server 64 in the control unit 18 of FIG. 5 may be through the Internet 20, as shown in FIG. 2. Additional networking and architectural details of the components shown in FIG. 5 are not relevant to the present disclosure and, hence, are not provided.

It is noted that, in the embodiments of FIGS. 5-6, the bi-directional messaging between different entities may be based on the Hypertext Transfer Protocol (HTTP) or the Hypertext Transfer Protocol Secure (HTTPS). In other embodiments, different protocols or messaging schemes may be used to effectuate communication related to the voucher-based electronic ticketing as per teachings of the present disclosure.

Referring again to FIGS. 5-6, a user 70 at a transit station (not shown) may approach the TVM 60 to buy one or more transit tickets, as noted at arrow 72. The TVM 60 may be configured to allow the user 70 to select and purchase—for example, through a touch-screen display (not shown)—a wide range of ticket types to numerous destinations served by, for example, the transit station operator or train/bus service operating company. For example, in one embodiment, in case of a bus service, the TVM 60 may offer the user 72 a choice of the following different types of bus tickets: (i) a basic (regular-priced) ticket for a single ride, (ii) a basic daily pass, (iii) a basic monthly pass, (iv) a basic semi-monthly pass (from 1st of the month through the 15th of the month), (v) a basic semi-monthly pass (from the 16th of the month through the end of the month), (vi) a discounted single ride ticket (for example, for senior citizens, students, transit company employees, individuals with disabilities, and the like, or for travel during off-peak time periods), (vii) a discounted daily pass, and (viii) a discounted monthly pass. In particular embodiments, the VGR user app 12 and the VGR server app 14 may be configured to support voucher code-based purchase of many such different types of tickets. As discussed below, the voucher code for the user-selected ticket(s) may be generated after the user makes the requisite payment at the TVM 60. In particular embodiments, the voucher code (at arrows 84, 86 discussed below) may remain valid for a pre-defined duration (for example, 120 minutes, 90 days, and the like). In one embodiment, the user 70 may need to buy the tickets again to obtain another voucher code if the current voucher code expires due to non-use during its validity period. In some embodiments, the validity of a voucher code may depend on the type of the ticket. For example, voucher codes for multiple digital passes purchased in a single transaction at a TVM, for monthly passes, for tickets during peak travel periods, and the like, may have longer validity than voucher codes issued for tickets at discounted fares, for single-use or daily tickets, and so on.

It is observed here that in the embodiments of FIGS. 5 and 6, the ticketing server 64 may be owned and/or operated by a commercial entity that is different from the entity operating or managing the TVM 60 and its associated TVM server 62. For example, the TVM 60 and the TVM server 62 may be owned and/or operated by a transit agency or transit service provider (for example, a train company, a bus company, or a public transit agency), which may be operating many such TVMs in the transit system. On the other hand, the ticketing server 64 may be owned by a vendor (or service provider) that provides a centralized, back-end order processing and ticketing support to multiple transit agencies or operators. Therefore, to streamline order processing and prevent unauthorized backend transactions from TVMs of third parties or non-affiliated transit agencies, in particular embodiments, such service provider may assign a unique, agency-specific client_ID (client identifier) to each transit agency utilizing the voucher code-based electronic ticketing support from the ticketing server 64. Additionally, in certain embodiments, in addition to the pre-defined client_ID, each transit agency (or transit operator) also may be provided an agency-specific client_key, which may be a secret code or secret “key”. The unique combination of client_ID and client_key may authorize an agency's TVMs and TVM server(s) to interface with the ticketing server 64, and may prevent an unauthorized third party from communicating with the ticketing server 64 in the backend system. In particular embodiments, the client_ID and the client_key may be stored on the TVM 60 or the TVM server 62, and may be passed back to the ticketing server 64 with each order for ticket(s) (as discussed below with reference to messaging at arrows 74, 76 in FIGS. 5-6) to ensure that the order is coming from an authorized TVM and/or TVM server.

As noted at block 97 in FIG. 6, the messaging shown in FIGS. 5-6 facilitates a passenger's use of electronic tickets—bought using a TVM (such as the TVM 60)—on a mobile app (such as the user app 12). Therefore, when the TVM 60 receives the payment for the passenger's 70 request for ticket(s) (at arrow 72), the TVM 60 may make a “Buy Ticket(s)” call to the TVM server 62, as noted at arrow 74. In a transit system, each TVM may have its own unique identifier (TVM_ID). Therefore, in certain embodiments, the ticket purchase request at arrow 74 may include the following: (i) the TVM_ID of the TVM 60 sending the request, (ii) the amount paid by the user 70 for the electronic ticket, and (iii) an identification of the type of the electronic ticket (daily pass, monthly pass, discounted rate ticket, and the like). If the unique client_ID and client_key values are stored on the TVM 60, then the ticket purchase request at arrow 74 also may contain these values as a pre-defined verification content (or client credentials) specific to the transit agency associated with the TVM 60 and offering the transit service.

Initially, the TVM server 62 may call the account API 66 in the ticketing server 64 to authenticate the ticket request from the TVM 60, as noted at arrow 76. The authentication request at arrow 76 may include the client_ID and client_key values, if received from the TVM 60. If the client_ID and client_key values are stored on the TVM server 62 (and not on the TVM 60), the server 62 may pass on those values as part of the authentication request to the account API 66 for verification. The account API 66 may determine that the pre-defined verification content or client credentials (here, the combination of the client_ID and client_key) are correct and that the TVM 60 (or the TVM server 62) is authorized to send a request for a voucher code. In response, the account API 66 may authenticate the request (at arrow 76) and issue an Order Authorization (Oauth) token (or access token) to the TVM server 62, as noted at arrow 78. The TVM server 62 may now call the voucher API 67 and use the access token to place an order with the voucher API for the user-requested ticket(s). In the embodiment of FIGS. 5-6, such an order may be in the form of an HTTP POST request to generate a voucher code for the user's order, as noted at arrow 80 in FIG. 5 and shown in more detail at arrow 80 in FIG. 6. In one embodiment, the POST request for voucher code may contain some or all of the earlier-mentioned information (for example, TVM_ID, ticket payment amount, and the like) received from the TVM 60 in its ticket purchase request at arrow 74. Additionally, in particular embodiments, the POST request at arrow 80 also may contain a Universal Unique Identifier (UUID) of the ticket to be issued to the user 70. In one embodiment, the UUID may be a unique, 16-byte number generated by the TVM 60 (and sent to the TVM server 62 as part of the ticket purchase request at arrow 74) or by the TVM server 62, and may be provided to the ticketing server 64 so that the same ticket number is associated with the user 70 in both the TVM server 62 (and, hence, the TVM 60) and the ticketing server 64. This ticket number may be later linked to the user's 70 initial order at the TVM 60 (at arrow 72) when the user 70 sends the voucher code to the control unit 18 (at arrow 90, discussed later below). It is observed here that a UUID may be used to uniquely identify an object—whether a product or a service—across the Internet. Although UUIDs are normally fixed, they may be dynamically-generated in certain implementations.

In response to the POST request (with TVM_ID and other parameters) at arrow 80, the voucher API 67 may generate and provide a voucher code as a response at arrow 82. As mentioned before, the voucher code may be an alpha-numeric code of pre-defined length and, in some embodiments, with a pre-determined validity period. In one embodiment, as part of its response at arrow 82, the voucher API 67 also may internally generate an order number uniquely linked to the voucher code being sent to the TVM server 62. In some embodiments, the order number may be a unique order UUID and may be generated based on the receipt of the authorization token and TVM_ID from the TVM server 62 during its interactions with the ticketing server 64. The TVM server 62 may forward the received voucher code to the TVM 60, as indicated at arrow 84 in FIGS. 5-6. As noted at arrow 86 in FIG. 6, the TVM 60, in turn, may display the voucher code for the user 70 to copy (or enter into the user's mobile device 17) and/or print the code on a TVM receipt (like the exemplary receipt 100 in FIG. 7) with instructions to the user 70 on how to use it. In particular embodiments, when the user 70 sends the voucher code to the control unit 18 (at arrow 90, discussed below), both the electronic ticket (as represented by its ticket number) and the internally-generated order number (mentioned earlier) may be linked to the purchaser/user 70, for example, for monitoring the user's usage of the ticket.

As per the teachings of the present disclosure, the user 70 may initially have to deploy the VGR user app 12 on his/her mobile device 17 to avail of the electronic ticketing functionality. In particular embodiments, the VGR user app 12 may provide a UI on the mobile device 17 to allow the user 70 to enter the voucher code in a specific data entry field (as shown in the exemplary screenshot 106 in FIG. 8B), as noted at arrow 88 in FIGS. 5-6. The user 70 may click a “send” or “enter” radio button on the UI to send the voucher code to the control unit 18. As a result, in one embodiment, the VGR user app 12 may send an HTTP PUT request with voucher code to the rider API 68, as noted at arrow 90 in FIGS. 5-6. In one embodiment, the ticketing server's 64 Uniform Resource Locator (URL) link (or web address) may be embedded in the VGR user app 12 to enable the app 12 to connect to the server 64 (and, hence, to the rider API 68), for example, via the Internet 20 (FIG. 2). In one embodiment, the rider API 68 may initially determine that the voucher code received from the mobile device (at arrow 90) is valid and unexpired. Based on the receipt of a valid and unexpired voucher code, the rider API 68 may generate/issue the corresponding electronic ticket(s), which may have the ticket number(s) received at arrow 80 (as mentioned before) for consistency between the data in the TVM server 62 and that in the ticketing server 64, and also for ease of tracking the usage/redemption of the ticket(s) in the transit system. Furthermore, as noted at arrow 92, in some embodiments, the voucher code from the mobile device 17 may enable the rider API 68 to link the issued ticket (as represented by its ticket number) and corresponding internally-generated order number by the voucher API 67 (mentioned earlier) to the purchaser/user 70. For example, the voucher code at arrow 90 may allow the rider API 68 to identify the source of the voucher code—here, the mobile device 17 and the associated VGR user app 12. Such identification may enable the rider API 68 to link the device user 70 to the issued electronic ticket(s) (and their corresponding order number(s)) so that any usage/redemption of the ticket(s) by the user may be monitored, for example, to keep track of user's usage of the transit service and also for accounting purpose (in case of future dispute or complaint by the user).

As mentioned before and as shown in the exemplary screenshot 110 in FIG. 8D, an electronic ticket may comprise multiple digital passes. The voucher code at arrow 90 may trigger the rider API 68 to recognize that the user 70 has purchased multiple digital passes. In that case, at arrow 92, the rider API 68 may link each digital pass and corresponding order to the user. Thereafter, the rider API 68 may deliver the issued electronic ticket(s) or digital pass(es) to the mobile device 17 using a success notification at arrow 94. In certain embodiments, the delivery of an electronic ticket at arrow 94 also may include transmission of corresponding ticket number (and, optionally, its order number) for tracking future usage/redemption of the ticket. Upon receipt of the success message at arrow 94, the VGR user app 12 may provide a visible notification of acceptance of the voucher code by the ticketing server 64 as shown in the exemplary screenshot 108 in FIG. 8C (discussed below). In certain embodiments, an audible notification also may be provided in place of or in addition to the visible notification on the UI.

The received electronic ticket(s) or digital pass(es) may be maintained in a user account within the VGR user app 12, as noted at arrow 98 in FIG. 6. The user app 12 may further allow the user 70 to see which transit tickets are electronically stored on the user's mobile device 17 as illustrated in the exemplary screenshot 110 in FIG. 8D (discussed below). In some embodiments, if the user has setup an online account with the transit service operator, the VGR user app 12 may allow the user to link the current purchases to that account, for example, for managing user's annual transit expense, or monitoring the user's travel pattern, and the like.

On the other hand, the rider API 68 may send a failure notification at arrow 94 if the voucher code received at arrow 90 has been redeemed already, or is expired (because of non-use during its validity period), or is an invalid code (for example, when the code received at arrow 90 is not identical to the code issued at arrow 86). In particular embodiments, the VGR user app 12 also may generate a visible and/or audible alert when the voucher code has been rejected by the rider API 68 in the ticketing server 64.

FIG. 7 shows an exemplary TVM receipt 100 with a voucher code according to one embodiment of the present disclosure. In some embodiments, in addition to or in place of displaying the voucher code, the TVM 60 in FIG. 5 may provide the voucher code to the user 70 on a printed receipt (such as the receipt 100) of the user's ticket-purchase transaction. The receipt 100 also may provide instructions to the user 70 as to how to “redeem” or use the voucher code. The user 70 may then enter the voucher code into a data entry field on the user's mobile device 17 as shown, for example, in FIG. 8B (discussed below). It is seen from the receipt 100 that the voucher code printed thereon may be a randomly-generated, alpha-numeric code having a pre-defined length of characters (for example, 8 characters as in case of the voucher code “1LPKU6V8” in FIG. 7). The alpha-numeric nature of the voucher code may make it difficult to remember in a rush (for example, when someone wishes to steal the voucher code quickly from the TVM screen or the receipt 100) and its manual entry into a data field (as opposed to the machine-based scanning of a QR code) may make it more difficult for its unauthorized copying. As mentioned before, in some embodiments, the voucher code may remain valid for a pre-defined duration (for example, 120 minutes, 90 days, and the like). The user may need to obtain another voucher code if the current voucher code expires due to non-use during its validity period.

FIGS. 8A-8D provide an exemplary illustration of sample screenshots of the mobile device 17 of FIG. 2 related to the voucher code entry and electronic ticket receipt and display. The screenshot 102 in FIG. 8A illustrates an exemplary “Settings” screen of the VGR user app 12. When the “Ticket Voucher” option 104 under the “Settings” menu is clicked by the user, a user interface (UI) with a data entry field may be displayed to the user as shown in the exemplary screenshot 106 in FIG. 8B. The user may manually enter the voucher code there and submit it for further processing. As discussed before, the user app 12 may send the manually-entered voucher code to the control unit 18 for receiving the corresponding electronic ticket. If the voucher code is valid and unexpired, the control unit 18 may send a success notification (such as that shown at arrow 94 in FIGS. 5-6) to the VGR user app 12, which, in turn, may provide a visible notification of acceptance of the voucher code to the user, as shown in the exemplary screenshot 108 of FIG. 8C. In particular embodiments, in addition to the visible notification of the screenshot 108, the VGR user app 12 also may provide an audible notification of the acceptance of the voucher code, for example, in the form of a specific sound or tone. In case of an invalid or expired voucher code, a failure notification or alert (visible and/or audible) may be similarly generated.

As mentioned earlier, in certain embodiments, an electronic ticket received from the control unit 18 may not be a single ticket, but rather may be a group of digital passes for the corresponding transit service offered by a transit company. For example, a passenger may purchase four (4) single-ride, daily passes for a train service in a single transaction at the TVM 60. In that case, the control unit 18 may send the four digital passes bundled together as an “electronic ticket.” Upon receiving such an “electronic ticket,” the VGR user app 12 may display each individual digital pass on the mobile device's 17 display screen (not shown) as illustrated by the exemplary screenshot 110 showing four digital passes 112-115 available for use by the passenger for the relevant transit service offered by the “Company” listed on each digital pass.

FIG. 9 is a block diagram of an exemplary mobile device 17 according to one embodiment of the present disclosure. As noted earlier, the mobile or wireless device 17 may be a UE, a smartphone, or any other wireless device operable for VGR user app-based electronic ticketing and other transit applications as per particular embodiments of the present disclosure. The wireless device 17 may include a processor 120, a memory 122 (which may, in some embodiments, also include memory on UE's Subscriber Identity Module (SIM) card), a transceiver 124, and an antenna unit 125. The memory 122 may include the program code for the VGR user app 12. The program code may be executed by the processor 120, which, in one embodiment, may be similar to the CPU 25 in FIG. 2. Upon execution of the user app's program code by the processor 120, the processor may configure the mobile device 17 to perform various mobile device-specific tasks associated with the electronic ticketing methodology as per the teachings of the present disclosure. In one embodiment, such tasks may include, for example, the process steps illustrated in FIG. 4 as well the messaging by the mobile app 12 in FIG. 6. Such tasks also may include, for example, mobile device-specific (or VGR user app-based) operations discussed earlier.

The memory 122 may store data or other related communications received from the control unit 18 (FIG. 2) as well as other content needed to facilitate voucher code-based electronic ticketing. For example, in one embodiment, the memory 122 may store, for example, pre-purchased electronic ticket(s) or digital passes received from the control unit 18, a passenger's itinerary information, electronic purchase receipts, and the like. In some embodiments, the memory 122 also may keep a record of voucher codes entered by the user, for example, during a pre-determined time period (such as, for example, last one year, or last 30 days).

The transceiver 124 may communicate with the processor 120 to perform transmission/reception of data, control, or other signaling information (via the antenna unit 125) to/from the controller unit 18 with which the mobile device 17 may be in communication. In the embodiment of FIGS. 5-6, the mobile device 17 may perform communication with the ticketing server 64, which, along with the TVM server 62, may operate as a “control unit” for the mobile device 17, as discussed before. In particular embodiments, the transceiver 124 may support wireless communication with the controller unit 18 through the Internet 20 to implement the electronic ticketing methodology as per the teachings of the present disclosure. The transceiver 124 may be a single unit or may comprise of two separate units—a transmitter (not shown) and a receiver (not shown). The antenna unit 125 may include one or more antennas. Alternative embodiments of the wireless device 17 may include additional components responsible for providing additional functionality, including any of the functionality identified herein, such as, for example, transmitting voucher information to the control unit 18, receiving electronic ticket(s) from the control unit 18, displaying various notifications or messages to the user of the device 17, etc., and/or any functionality necessary to support the solution as per the teachings of the present disclosure. For example, in one embodiment, the wireless device 17 may also include an on-board power supply unit 127 (e.g., a battery or other source of power) to allow the device to be operable in a mobile manner.

In one embodiment, the mobile device 17 may be configured (in hardware, via software, or both) to implement device-specific aspects of voucher code-based electronic ticketing as per teachings of the present disclosure. As noted before, the software or program code may be part of the VGR user app 12 and may be stored in the memory 122 and executable by the processor 120. For example, when existing hardware architecture of the device 17 cannot be modified, the functionality desired of the device 17 may be obtained through suitable programming of the processor 120 using the program code of the VGR user app 12. The execution of the program code (by the processor 120) may cause the processor to perform as needed to support various aspects related to electronic ticketing as per the teachings of the present disclosure. Thus, although the wireless device 17 may be referred to as “performing,” “accomplishing,” or “carrying out” (or similar such other terms) a function/task or a process or a method step, such performance may be technically accomplished in hardware and/or software as desired.

FIG. 10 depicts a block diagram of an exemplary computing unit 130 according to one embodiment of the present disclosure. The computing unit or system 130 represents the earlier-discussed control unit 18 (FIGS. 2 and 5), or any of the application-specific servers 62,64 (FIG. 5). In some embodiments, the computing unit 130 may represent the architecture of a non-server device as well—such as, for example, the TVM 60. The computing unit 130 may be suitably configured—in hardware and/or software—to implement the voucher code-based electronic ticketing methodology according to the teachings of the present disclosure. The computing unit 130 may include a processor 132 and ancillary hardware to accomplish the voucher code-based electronic ticketing-related tasks discussed before. In one embodiment, the processor 132 may be similar to the CPU 32 in FIG. 2. The processor 132 may be configured to interface with a number of external devices. In one embodiment, a number of input devices 134 may be part of the system 130 and may provide data inputs—such as user input, camera images, statistical data, and the like—to the processor 132 for further processing. The input devices 134 may include, for example, a touchpad, a camera, a proximity sensor, a computer keyboard, a touch-screen, a joystick, a physical or virtual “clickable button,” a computer mouse/pointing device, and the like. In FIG. 10, the processor 132 is shown coupled to a system memory 136, a peripheral storage unit 138, one or more output devices 140, and a network interface unit 142. A display screen is an example of an output device 140. In some embodiments, the computing unit 130 may include more than one instance of the devices (or components) shown. In various embodiments, all of the components shown in FIG. 10 may be housed within a single housing. In other embodiments, the computing unit 130 may not include all of the components shown in FIG. 10. Furthermore, the computing unit 130 may be configured as a standalone system, as a server system, as a client system, or in any other suitable form factor (including a distributed processing system like that shown in FIG. 5).

In particular embodiments, the computing unit 130 may include more than one processor (e.g., in a distributed processing configuration). When the computing unit 130 is a multiprocessor system, there may be more than one instance of the processor 132 or there may be multiple processors coupled to the processor 132 via their respective interfaces (not shown). The processor 132 may be a System on Chip (SoC) and/or may include more than one Central Processing Units (CPUs).

The system memory 136 may be any semiconductor-based storage system such as, for example, Dynamic Random Access Memory (DRAM), Static RAM (SRAM), Synchronous DRAM (SDRAM), Rambus® DRAM, flash memory, various types of Read Only Memory (ROM), and the like. In some embodiments, the system memory 136 may include multiple different types of semiconductor memories, as opposed to a single type of memory. In certain embodiments, some or all of the system memory 136 may be a cloud-based storage unit or a remotely-implemented network storage. In particular embodiments, the system memory 136 may be a non-transitory data storage medium.

The peripheral storage unit 138, in various embodiments, may include support for magnetic, optical, magneto-optical, or solid-state storage media such as hard drives, optical disks (such as Compact Disks (CDs) or Digital Versatile Disks (DVDs)), non-volatile Random Access Memory (RAM) devices, Secure Digital (SD) memory cards, Universal Serial Bus (USB) memories, and the like. In some embodiments, the peripheral storage unit 138 may be coupled to the processor 132 via a standard peripheral interface such as a Small Computer System Interface (SCSI) interface, a Fibre Channel interface, a Firewire® (IEEE 1394) interface, a Peripheral Component Interface Express (PCI Express™) standard based interface, a USB protocol based interface, or another suitable interface. Various such storage devices may be non-transitory data storage media. In certain embodiments, the peripheral storage may be a cloud-based storage or a network drive.

As mentioned earlier, a display screen may be an example of the output device 140. Other examples of an output device include a graphics/display device, a computer screen, an alarm system, or any other type of data output device. In some embodiments, the input device(s) 134 and the output device(s) 140 may be coupled to the processor 132 via an I/O or peripheral interface(s).

In one embodiment, the network interface unit 142 may communicate with the processor 132 to enable the computing unit 130 to couple to a network or a communication interface. In another embodiment, the network interface unit 142 may be absent altogether. The network interface 142 may include any suitable devices, media and/or protocol content for connecting the computing unit 130 to a network/interface—whether wired or wireless. In various embodiments, the network may include Local Area Networks (LANs), Wide Area Networks (WANs), wired or wireless Ethernet, telecommunication networks, or other suitable types of networks/interfaces. For example, the network may be a packet-switched network such as, for example, an Internet Protocol (IP) network like the Internet 20 (FIG. 2), a circuit-switched network, such as the Public Switched Telephone Network (PSTN), or a combination of packet-switched and circuit-switched networks. In another embodiment, the network may be an IP Multimedia Subsystem (IMS) based network, a satellite-based communication link, a Bluetooth network/interface, a Near Field Communication (NFC) based network/interface, a Worldwide Interoperability for Microwave Access (WiMAX) system based on Institute of Electrical and Electronics Engineers (IEEE) standard IEEE 802.16e, an IP-based cellular network such as, for example, a Third Generation Partnership Project (3GPP) or 3GPP2 cellular network like a Long Term Evolution (LTE) network, a combination of cellular and non-cellular networks, a proprietary corporate network, a Public Land Mobile Network (PLMN), an Ethernet connection, and the like.

The computing unit 130 may include an on-board power supply unit 145 to provide electrical power to various system components illustrated in FIG. 10. The power supply unit 145 may receive batteries or may be connectable to an AC electrical power outlet. In one embodiment, the power supply unit 145 may convert solar energy or other renewable energy into electrical power.

In one embodiment, a non-transitory, computer-readable data storage medium, such as, for example, the system memory 136 or a peripheral data storage unit 138, such as a removable memory, may store program code or software for the VGR server app 14. In the embodiment of FIG. 10, the system memory 136 is shown to include such program code, as indicated by a dotted block with reference numeral “14”. The processor 132 may be configured to execute the program code, whereby the computing unit 130 may be operative to perform various control unit-specific tasks associated with the voucher code-based electronic ticketing methodology as per the teachings of the present disclosure. In one embodiment, such tasks may include, for example, some or all of the process steps illustrated in any of the FIGS. 3 and 6. Such tasks also may include, for example, relevant control unit-based operations discussed earlier with reference to FIGS. 2 and 5. The program code or software may be proprietary software or open source software which, upon execution by the processor 132, may enable the computing unit 130 to perform controller unit-specific operations to support the voucher code-based electronic ticketing aspects as per teachings of the present disclosure as well as to support other related actions (such as, for example, interacting with a TVM). In certain embodiments, the program code for the VGR server app 14 may operate in conjunction with additional program code in the memory 136 to enable the computing unit 130 to perform the control unit-related tasks.

In the preceding description, for purposes of explanation and not limitation, specific details are set forth (such as particular architectures, interfaces, techniques, etc.) in order to provide a thorough understanding of the disclosed technology. However, it will be apparent to those skilled in the art that the disclosed technology may be practiced in other embodiments that depart from these specific details. That is, those skilled in the art will be able to devise various arrangements which, although not explicitly described or shown herein, embody the principles of the disclosed technology. In some instances, detailed descriptions of well-known devices, circuits, and methods are omitted so as not to obscure the description of the disclosed technology with unnecessary detail. All statements herein reciting principles, aspects, and embodiments of the disclosed technology, as well as specific examples thereof, are intended to encompass both structural and functional equivalents thereof. Additionally, it is intended that such equivalents include both currently known equivalents as well as equivalents developed in the future, such as, for example, any elements developed that perform the same function, regardless of structure.

Thus, for example, it will be appreciated by those skilled in the art that block diagrams herein (e.g., in FIGS. 2 and 5) can represent conceptual views of illustrative circuitry or other functional units embodying the principles of the technology. Similarly, it will be appreciated that the flowcharts in FIGS. 3-4 and the messaging diagram in FIG. 6 represent various processes or tasks which may be substantially performed by a respective processor (e.g., the processor 120 in FIG. 9 or the processor 132 in FIG. 10, as applicable). Such a processor may include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Some or all of the functionalities described above in the context of FIGS. 1-8 also may be provided by a respective processor 120 or 132, in the hardware and/or software. Any of the processors 120 and 132 may employ distributed processing in certain embodiments.

When certain inventive aspects require software-based processing, such software or program code may reside in a computer-readable data storage medium. As noted earlier with reference to FIG. 10, such data storage medium may be part of the peripheral storage 138, the system memory 136, and/or the processor's 132 internal memory (not shown). In case of the embodiment in FIG. 9, such data storage medium may be part of the memory 122 or the processor's 120 internal memory (not shown). In certain embodiments, the processors 120 and 132 may execute instructions stored on a respective such medium to carry out the software-based processing. The computer-readable data storage medium may be a non-transitory data storage medium containing a computer program, software, firmware, or microcode for execution by a general purpose computer or a processor mentioned above. Examples of computer-readable storage media include a ROM, a RAM, a digital register, a cache memory, semiconductor memory devices, magnetic media such as internal hard disks, magnetic tapes and removable disks, magneto-optical media, and optical media such as CD-ROM disks and DVDs.

Alternative embodiments of the computing unit 130 according to inventive aspects of the present disclosure may include additional components responsible for providing additional functionality, including any of the functionality identified above and/or any functionality necessary to support the solution as per the teachings of the present disclosure. Although features and elements are described above in particular combinations, each feature or element can be used alone without the other features and elements or in various combinations with or without other features. As mentioned before, various VGR server application-based functions and VGR user application-based functions discussed herein may be provided through the use of hardware (such as circuit hardware) and/or hardware capable of executing software/firmware in the form of coded instructions or microcode stored on a computer-readable data storage medium (mentioned above). Thus, such functions and illustrated functional blocks are to be understood as being either hardware-implemented and/or computer-implemented, and thus machine-implemented.

The foregoing describes an electronic-ticketing approach in a transit system in which a user of a mobile device receives a voucher code at a TVM in a transit station, enters the voucher code into the user's mobile device, and sends it to a control unit to receive an electronic ticket from the control unit delivered to the user's mobile device. The voucher code is a randomly-generated, alpha-numeric code that can be displayed on TVM displays and also can be easily be printed on TVM receipts. When the control unit receives the voucher code, it links the electronic ticket to the user before delivering the ticket to the user's mobile device so as to keep a track of the user's usage of the ticket. A software module provides a user app portion for the user's mobile device and a server app portion for the control unit, both of which operate in conjunction with each other.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

What is claimed is:

1. A method in a control unit associated with a transit system, the method comprising:
receiving, from a Ticket Vending Machine (TVM) in the transit system, a request for a voucher code to be provided to a user of a mobile device for purchase of an electronic ticket for a transit service;
authenticating the received request;
sending the voucher code to the TVM to be provided to the user;
receiving the voucher code sent by the user from the mobile device; and
delivering the electronic ticket to the mobile device.

2. The method of claim 1, wherein the method comprises performing the following using the control unit before sending the voucher code:
generating an authorization token upon authenticating the request; and
generating an order number based on the authorization token and on an identifier of the TVM (TVM_ID), wherein the order number is uniquely linked to the voucher code.

3. The method of claim 2, wherein the method comprises performing the following using the control unit before delivering the electronic ticket:
determining that the voucher code received from the mobile device is valid and unexpired; and
based on the voucher code received from the mobile device, linking the electronic ticket and the order number to the user.

4. The method of claim 3, wherein the electronic ticket comprises a plurality of digital passes, wherein linking the electronic ticket comprises:
linking each digital pass in the plurality of digital passes to the user; and
wherein delivering the electronic ticket comprises:
delivering the plurality of digital passes to the mobile device of the user.

5. The method of claim 1, wherein the voucher code is an alpha-numeric code having a pre-defined number of characters, and wherein the voucher code is valid for a pre-defined duration.

6. The method of claim 1, wherein receiving the request comprises:
receiving the following as part of the request:
an amount paid by the user for the electronic ticket;
an identification of a type of the electronic ticket; and
a pre-defined verification content specific to a transit agency associated with the TVM and offering the transit service.

7. The method of claim 6, wherein authenticating the request comprises:
determining that the pre-defined verification content is correct;
based on the determination, confirming that the TVM is authorized to send the request for the voucher code; and
authenticating the request based on confirming that the TVM is authorized.

8. A method in a mobile device for receiving an electronic ticket on the mobile device for a transit service, the method comprising:
receiving a voucher code from a user operating the mobile device, wherein the voucher code is an alpha-numeric code and is obtained by the user from a Ticket Vending Machine (TVM) in a transit system for the transit service;
sending the voucher code to a ticketing server in the transit system as part of a request for the electronic ticket, wherein the voucher code enables the ticketing server to link the electronic ticket to the user; and
receiving the electronic ticket from the ticketing server for storage into the mobile device.

9. The method of claim 8, wherein the electronic ticket comprises a plurality of digital passes for the transit service, and wherein receiving the electronic ticket comprises:
displaying the plurality of digital passes on a display screen of the mobile device.

10. The method of claim 8, wherein receiving the voucher code comprises:
displaying a data entry field on a display screen of the mobile device; and
allowing the user to manually enter the voucher code into the data entry field.

11. The method of claim 8, further comprising at least one of the following:
providing a visible notification of acceptance of the voucher code by the ticketing server on the mobile device;
providing an audible notification of the acceptance of the voucher code by the ticketing server on the mobile device; and
generating an alert for the user when the voucher code is invalid or expired.

12. A control unit in a transit system, wherein the control unit comprises:
an interface unit operable to receive, from a Ticket Vending Machine (TVM) in the transit system, a request for a voucher code to be provided to a user of a mobile device for purchase of an electronic ticket for a transit service;
a memory for storing program instructions and the request for the voucher code; and
a processor coupled to the interface unit and to the memory, wherein the processor is operable to execute the program instructions, which, when executed by the processor, cause the control unit to perform the following:
authenticate the received request,
generate the voucher code,
send the voucher code, using the interface unit, to the TVM to be provided to the user,
subsequently receive, using the interface unit, the voucher code sent by the user from the mobile device, and
deliver the electronic ticket to the mobile device using the interface unit.

13. The control unit of claim 12, wherein the program instructions, upon execution by the processor, cause the control unit to further perform the following before sending the voucher code to the TVM:
generate an authorization token upon authenticating the request;
generate an order number based on the authorization token and on an identifier of the TVM (TVM_ID); and
link the order number to the voucher code.

14. The control unit of claim 13, wherein the program instructions, upon execution by the processor, cause the control unit to further perform the following before delivering the electronic ticket to the mobile device:
determine that the voucher code received from the mobile device is valid and unexpired; and
based on the voucher code received from the mobile device, link the electronic ticket and the order number to the user.

15. The control unit of claim 12, wherein the voucher code is an alpha-numeric code having a pre-defined number of characters, and wherein the voucher code is valid for a pre-defined time period.

16. The control unit of claim 12, wherein the interface unit is operable to receive the following as part of the request:
a pre-defined verification content specific to a transit agency associated with the TVM and offering the transit service;
and wherein the program instructions, upon execution by the processor, cause the control unit to further perform the following as part of authenticating the request received by the interface unit:
determine that the pre-defined verification content is correct,
based on the determination, confirm that the TVM is authorized to send the request for the voucher code, and
authenticate the request based on confirming that the TVM is authorized.

17. A transit system comprising:
a first server operable to send a first request to a second server for a voucher code to be provided to a user of a mobile device for purchase of an electronic ticket for a transit service; and
the second server communicatively coupled to the first server and operable to perform the following:
authenticate the received first request,
send the voucher code to the first server to be provided to the user,
receive the voucher code sent by the user from the mobile device, and
deliver the electronic ticket to the mobile device.

18. The transit system of claim 17, further comprising:
a Ticket Vending Machine (TVM) communicatively coupled to the first server and operable to perform the following:
receive a second request from the user for the voucher code; and
send the second request to the first server; and
wherein the first server is operable to further perform the following:
generate the first request from the second request and send the first request to the second server, and
send the voucher code received from the second server to the TVM for delivery to the user.

19. The transit system of claim 17, wherein the first server is operable to send the following to the second server as part of the first request:
a pre-defined verification content specific to a transit agency associated with the first server and offering the transit service; and
wherein the second server is operable to perform the following:
determine that the pre-defined verification content is correct,
based on the determination, confirm that the first server is authorized to send the first request for the voucher code,
authenticate the first request based on confirming that the first server is authorized, and
upon authenticating the first request, send an authorization token to the first server to enable the first server to receive the voucher code from the second server.

20. The transit system of claim 17, wherein the voucher code is an alpha-numeric code having a pre-defined number of characters, and wherein the voucher code is valid for a pre-defined duration.
